(19) United States
(12) Patent Application Publication
(10) Pub. No.: US 2025/0077381 A1
(43) Pub. Date: Mar. 6, 2025

(54) DEVICE-ABNORMALITY DETECTION METHOD AND DEVICE-ABNORMALITY DETECTION SYSTEM

(71) Applicant: Aktiebolaget SKF, Göteborg (SE)

(72) Inventors: Jinshi CUI, Shanghai (CN); Kaihuan ZHANG, Hangzhou (CN); Gang CHENG, Shanghai (CN)

(21) Appl. No.: 18/811,436

(22) Filed: Aug. 21, 2024

(30) Foreign Application Priority Data
Aug. 31, 2023 (CN) 202311120436.X

(51) Int. Cl. G06F 11/34

(52) U.S. Cl. CPC G06F 11/3447; G06F 2201/875

(57) ABSTRACT

A device-abnormality detection method and a device-abnormality detection system are disclosed. The device-abnormality detection method includes: generating, by a local detection terminal, target performance index data of a device to be detected, and sending the target performance index data to a cloud platform. The method may include determining, by the cloud platform based on the target performance index data, target detection algorithm information corresponding to the target performance index data, and sending the target detection algorithm information to the local detection terminal. The method may also include implementing, by the local detection terminal, an abnormality detection of the device to be detected based on the target detection algorithm information and performance data of the device to be detected, and outputs an abnormality detection result.

### CROSS-REFERENCE TO RELATED APPLICATION

This application claims priority to Chinese Application No. 202311120436.X, filed Aug. 31, 2023, the entirety of which is hereby incorporated by reference.

### TECHNICAL FIELD

The present disclosure relates to the field of detection control, and more particularly to a device-abnormality detection method and a device-abnormality detection system.

### BACKGROUND

With the widespread use of detection technologies in civilian and commercial fields, detection systems, particularly device-abnormality detection systems, are also facing higher demands.

Current device-abnormality detection systems typically include a local detection terminal on the device side (also referred to as edge terminal) and a remote cloud platform (also referred to as cloud terminal). However, current local detection terminals upload large amounts of collected real-time detection data to the cloud terminal, where the detection data is subjected to comprehensive processing (e.g., multiple processes including pre-processing, feature extraction, abnormality detection, etc.), and the resulting abnormality detection result is computed and sent to the local detection terminals. However, on the one hand, real-time transmission of a large amount of data is required between a local detection terminal and a cloud platform via a wireless network, data throughput per unit time is too large, causing consumption of network space and resources, resulting in problems of high communication traffic (cost) and high energy consumption, and at the same time, the service life of the wireless system is greatly impaired. On the other hand, a large amount of raw data that is not sufficiently preprocessed is subjected to complex algorithm processing in the cloud terminal, which greatly increases the amount of computation and data processing in the cloud terminal, and also severely affects the timeliness of abnormality diagnosis, resulting in problems such as slow response speed and high latency.

Therefore, there is a need for an abnormality detection method and system which further implement abnormality detection process with high real-time, high response speed, and low latency on the premise of achieving good abnormality detection, and which can effectively reduce the large-scale data transmission between a cloud terminal and a local terminal, reduce communication traffic, and reduce power consumption.

### SUMMARY

In view of the above problems, the present disclosure provides a device-abnormality detecting method and a device-abnormality detecting system. With the device-abnormality detection method provided by the present disclosure, it is possible to further achieve an abnormality detection process with high real-time, high response speed, and low latency on the premise of achieving good abnormality detection, and effectively reduce the large-scale data transmission between the cloud terminal and the local terminal, reduce communication traffic and reduce energy consumption.

According to an aspect of the present disclosure, a device-abnormality detection method is proposed, which comprises: generating, by a local detection terminal, and target performance index data of a device to be detected, and sending the target performance index data to a cloud platform; determining, by the cloud platform based on the target performance index data, target detection algorithm information corresponding to the target performance index data, and sending the target detection algorithm information to the local detection terminal; implementing, by the local detection terminal, an abnormality detection of the device to be detected based on the target detection algorithm information and performance data of the device to be detected, and outputs an abnormality detection result.

In some embodiments, the generating, by the local detection terminal, target performance index data of the device to be detected comprises: capturing, by the local detection terminal, performance data of the device to be detected; determining, by the local detection terminal, the target performance index data based on a preset rule and the performance data, and sending the target performance index data to the cloud platform.

In some embodiments, the determining, by the cloud platform based on the target performance index data, target detection algorithm information corresponding to the target performance index data comprises: determining, by the cloud platform based on the target performance index data, the target abnormality detection algorithm information corresponding to the target performance index data, via a pre-trained machine learning model.

In some embodiments, the target abnormality detection algorithm information comprises target pre-processing model information, target feature extraction model information, and target abnormality detection model information.

In some embodiments, the determining target abnormality detection algorithm information corresponding to the target performance index data comprises: comparing the target performance index data with a plurality of preset target performance index data grades, determining a target performance index data grade corresponding to the target performance index data; determining target abnormality detection algorithm information corresponding to the target performance index data grade, based on the target performance index data grade and based on a preset rule.

In some embodiments, the implementing, by the local detection terminal, an abnormality detection of the device to be detected based on the target detection algorithm information and performance data of the device to be detected comprises: determining a target pre-processing model, a target feature extraction model, and a target abnormality detection model of the device to be detected, based on the target detection algorithm information; pre-processing the performance data based on the target pre-processing model, to obtain pre-processed performance data; extracting features of the pre-processed performance data based on the target feature extraction model to obtain device feature data; determining a performance state of the device to be detected according to the target abnormality detection model based on the pre-processed performance data and/or the device feature data.

In some embodiments, the machine learning model is a clustering model.

In some embodiments, the determining target performance index data based on a preset rule and based on the performance data comprises: for at least one of the performance data: acquiring data types of the performance data and obtaining index grade ranges corresponding to the data types, wherein each index grade range has corresponding index grade information; determining an index grade range to which the performance data corresponds, and acquiring the corresponding index grade information; and generating target performance index data based on the index grade information corresponding to each of the performance data.

In some embodiments, wherein the device to be detected is a gear grinder, and wherein the target performance index data includes rotational speed data of the gear grinder and feed rate data of the gear grinder; and the performance data includes at least one of rotational speed data of the gear grinder, feed rate data of the gear grinder, power data of the gear grinder, vibration data of the gear grinder.

According to another aspect of the present disclosure, a device-abnormality detection system is presented. The device-abnormality detection system comprises a local detection terminal and a cloud platform, and is configured to perform the method as described above.

### BRIEF DESCRIPTION OF DRAWINGS

In order to illustrate the technical solutions of the embodiments of the present disclosure more clearly, the following will simply introduce the accompanying drawings to be used in the description of the embodiments, and it is obvious that the accompanying drawings in the following description are only some embodiments of the present disclosure, and other drawings can be obtained according to these drawings for those of ordinary skill in the art without making inventive work. The following drawings are not deliberately drawn to the same scale as actual dimensions, emphasis instead is placed upon illustrating the subject matter of the present disclosure.

FIG. 1A illustrates an exemplary flowchart of a device-abnormality detection method according to an embodiment of the present disclosure;

FIG. 1B shows a schematic diagram of a device-abnormality detection method according to an embodiment of the present disclosure;

FIG. 2 illustrates an exemplary flowchart of a process S102 of determining target abnormality detection algorithm information according to an embodiment of the present disclosure;

FIG. 3 illustrates an exemplary flowchart of a process S103 of abnormality detection of the device to be detected according to an embodiment of the present disclosure.

### DETAILED DESCRIPTION

The technical solutions in the embodiments of the present disclosure will be clearly and completely described below in conjunction with the accompanying drawings, it is obvious that the described embodiments are only partial embodiments of the present disclosure, rather than all of the embodiments. Based on the embodiments of the present disclosure, all other embodiments obtained by those of ordinary skill in the art without making inventive work also belong to the scope of protection of the present disclosure.

As used in this application and the claims, the words “a”, “an”, and/or “the” do not refer to the singular, but may include the plural unless the context clearly dictates otherwise. In general, the terms “comprises” and “comprising” only imply the inclusion of the steps and elements specifically identified, these steps and elements do not constitute an exclusive list and a method or apparatus may also contain other steps or elements.

Although the present application makes various references to certain modules in a system according to embodiments of the present application, any number of different modules may be used and run on a user terminal and/or server. The modules are illustrative only and different aspects of the system and method may use different modules.

Flowcharts are used herein to illustrate operations performed by a system according to an embodiment of the present application. It should be understood that the preceding or following operations do not have to be performed exactly in order. Rather, the various steps may be processed in reverse order or simultaneously, as desired. At the same time, other operations may also be added to the processes, or certain step or steps of operations may be removed from the processes.

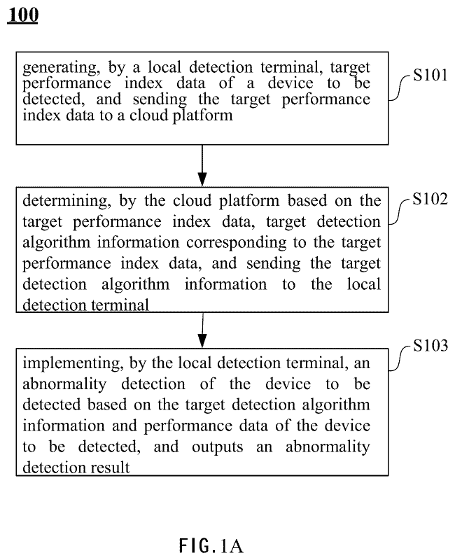

FIG. 1A illustrates an exemplary flowchart of a device-abnormality detection method according to an embodiment of the present disclosure. FIG. 1B shows a schematic diagram of a device-abnormality detection method according to an embodiment of the present disclosure.

It should be understood that the device-abnormality detection method refers to a method for detecting whether a target device (i.e., a device to be detected) is in an abnormal operation/performance state. It has a local detection terminal and a remote cloud platform disposed within the vicinity of the device to be detected.

It should be understood that the local detection terminal refers to an apparatus for realizing a detection process of the device to be detected, which is provided in the vicinity of the device to be detected to measure a plurality of performance data of the device to be detected in operation.

It will be appreciated that the local detection terminal may be, for example, an integrated sensor system, or may also be an integrated controller chip or the like. Embodiments of the present disclosure are not limited by the specific component of this local detection terminal.

The cloud platform refers to a cloud computing platform, which is a service platform for providing computing, networking and storage capabilities based on hardware resources and software resources. It may, for example, comprise a remote cloud server, or may also be a remote Internet of Things system or comprehensive computing system. Embodiments of the present disclosure are not limited by the specific component of the cloud platform.

The local detection terminal may communicate with the cloud platform, for example, via a wireless network. Embodiments of the present disclosure are not limited by the specific manner of communication and communication protocol between the local detection terminal and the cloud platform, e.g., via a cellular network, or via a short-range communication network (e.g., zigbee, Bluetooth communication, etc.).

Referring to FIGS. 1A and 1B, the device-abnormality detecting method 100 includes: first, in step S101, a local detection terminal generates target performance index data of a device to be detected, and sends the target performance index data to a cloud platform.

The target performance index data is data obtained based on the performance data of the device to be detected and intended to reflect the current overall performance level of the device to be detected. The target performance index data will then be used to determine the abnormality detection algorithm corresponding to the device to be detected.

For example, the target performance index data may be determined based on the performance data, e.g. taking a certain type of performance data of the performance data of the device to be detected as target performance index data, which can reflect the core performance or the overall performance of the device to be detected. For example, rotational speed data is taken as target performance index data. Alternatively, one or more types of performance data may be processed and target performance index data may be calculated.

It should be understood that the target performance index data may for example comprise a plurality of data types, which may for example be rotational speed data, machine tool feed rate data, power data, vibration data, temperature data, etc., depending on the actual type of device to be detected and its specific application scenario. Embodiments of the present disclosure are not limited by the specific component of this target performance index data.

Thereafter, in step S102, the cloud platform determines, based on the target performance index data, target detection algorithm information corresponding to the target performance index data, and transmits the target detection algorithm information to a local detection terminal.

The target detection algorithm information refers to information for identifying an algorithm that implements detection of the device to be detected. In one aspect, the target detection algorithm may be, for example, a single integrated or comprehensive algorithm, or it may be a plurality of algorithms, including, for example, a target pre-processing algorithm, a target feature extraction algorithm, and a target abnormality detection algorithm, respectively. On the other hand, the target detection algorithm information may be, for example, digital information, or it may be text information, or it may be a character string or binary-coded information. Embodiments of the present disclosure are not limited by the type of this target detection algorithm information and its components.

It should be appreciated that determining target detection algorithm information corresponding to the target performance index data may include, for example, determining target abnormality detection algorithm information corresponding to the target performance index data based on the target performance index data via a pre-trained machine learning model. Or, for example, the target detection algorithm information may also be determined based on a comprehensive algorithm or a calculation function.

After sending the target detection algorithm information to the local detection terminal, in step S103, the local detection terminal implements abnormality detection of the device to be detected based on the target detection algorithm information and the performance data of the device to be detected, and outputs an abnormality detection result.

The performance data of the device to be detected refers to data characterizing the performance of one or more aspects of the device to be detected. The performance data can be, for example, data collected by the sensor device from the device to be detected, which can be, for example, analog data, or can also be digital data, which can be, for example, data collected in real-time, or can also be data collected cyclically with a preset period. Embodiments of the present disclosure are not limited by the manner in which this performance data is acquired and the type thereof.

The performance data may be, for example, temperature data, magnetic field data, vibration data, rotational speed data, rotational acceleration data, power data, or the like. Embodiments of the present disclosure are not limited by the specific component of this performance data.

The local detection terminal implements abnormality detection of the device to be detected based on the target detection algorithm information and the performance data of the device to be detected, for example, including determining one or more target algorithm models based on the acquired target detection algorithm information, and applying the one or more target algorithm models to process the performance data to obtain an abnormality detection result of the device to be detected.

It should be appreciated that the abnormality detection result may include, for example, a performance abnormal state or a performance normal state. Or it may also include performance state and corresponding failure point predictions and suggestions for subsequent processing, and the like. The embodiments of the present disclosure are not limited by the specific content of this abnormality detection result.

Based on the above, compared with the present technical solution in which a large amount of real-time detection data is uploaded by the local terminal to the cloud, a comprehensive processing judgment is performed on the detection data at the cloud and the result is sent to the local terminal, first, the present application drastically reduces the amount of data transmission between the local detection terminal and the cloud platform by sending the target performance index data obtained based on the performance data instead of sending a large amount of real-time collected data, so that the cost of communication traffic can be reduced, and the energy consumption can be reduced. Secondly, by setting a cloud platform to determine target detection algorithm information corresponding to the target performance index data based only on the target performance index data without performing substantial complex algorithm solving, and setting the local detection terminal to determine, based on the target detection algorithm information and the performance data of the device to be detected, abnormality detection on the device to be detected is realized and an abnormality detection result is output, so that a calculation amount, a data processing amount and a data transmission amount of the cloud platform can be reduced, thereby guaranteeing reliable data transmission in real time between the cloud platform and the local detection terminal, improving a time-effectiveness of an overall detection process, and reducing a delay problem due to excessive data throughput of the cloud platform, Thus, on the premise of achieving good abnormality detection, it takes into account high real-time, high response speed, low latency, and low communication cost and energy consumption.

In some embodiments, the local detection terminal generates target performance index data of the device to be detected, including firstly, the local detection terminal captures performance data of the device to be detected; secondly, the local detection terminal generates target performance index data based on the performance data and based on a preset rule, and sends the target performance index data to the cloud platform.

For example, according to the actual situation, it may be set that the performance index data includes a plurality of data contents, and the collected performance data is compared with the plurality of data contents, the target performance index data is determined based on the comparison result. Alternatively, calculations and pre-processing may be performed based on performance data collected over a period of time to generate target performance index data.

Next, the process of generating target performance index data based on preset rules will be described in conjunction with specific embodiments. For example, the target performance index data may be set as rotational speed data of the device to be detected and the target performance index data is previously set to include two data contents: 3000 cpm (cycles/minute) for the first performance index data and 6000 cpm (cycles/minute) for the second performance index data. The process of determining the target performance index data may include, for example: collecting the current rotational speed data of the device to be detected; comparing the current rotational speed data with the first performance index data and second performance index data, and determining the performance index data having the smallest numerical difference with the current rotational speed data as the target performance index data. For example, if the current rotational speed data is 5500 cpm, the second performance index data 6000 cpm may be determined as the target performance index data.

Based on the above, in the present application, the local detection terminal is set to generate target performance index data based on the performance data and based on a preset rule, and the target performance index data is sent to the cloud platform, so that compared with the direct transmission of a large amount of real-time collected data, in the present application, by first filtering and pre-processing data at the local detection terminal, determining target performance index data capable of maximally reflecting the performance state of the device to be detected, and sending the target performance index data, the amount of data and the type of transmitted data are reduced massively, the consumption of network space and resources is reduced, and the communication cost is saved.

In some embodiments, the above-described process of determining target performance index data based on the performance data and based on preset rules may be described more specifically.

First, for at least one of the performance data: data types of the performance data may be required, and index grade ranges corresponding to the data types may be obtained, wherein each index grade range has corresponding index grade information. Thereafter, an index grade range to which the performance data corresponds is determined, and corresponding index grade information is acquired. Finally, target performance index data is generated based on the index grade information corresponding to each of the performance data.

For example, if the currently acquired performance data includes rotational speed data of 4000 cpm (cycles per minute) and a feed rate of 65%, an index grade range corresponding to the rotational speed data type and the feed rate data type may be obtained. For example, the corresponding rotational speed data type has a first index grade range: 2900-5900 cpm (cycles per minute), and a second index grade range: 6000-8000 cpm. The index grade information corresponding to the first index grade range is 3000 cpm and the index grade information corresponding to the second index grade range is 6000 cpm (it should be understood that the index grade information here refers to tag information for identifying the index grade, which aims to simply and unambiguously divide different grades). The index grade corresponding to the feed rate data type includes, for example, four grade ranges: a first-grade range of 0-30% (the corresponding index grade information is 20%), a second-grade range of 31-60% (the corresponding index grade information is 50%), and a third-grade range of 61-100% (the corresponding index grade information is 80%).

Then at this time, for example, it is possible to determine the index grade range corresponding to the performance data of the current device to be detected, and acquire the corresponding index grade information. Specifically, at this time, it is known that 4000 cpm (cycles/minute) of the current device to be detected corresponds to the first index grade range of 2900-5900 cpm (the corresponding index grade information is 3000 cpm), and that 65% of the current device to be detected corresponds to the second index grade range of 31-60% (the corresponding index grade information is 50%), thereby obtaining that the index grade information corresponding to the current two items of performance data is “Rotational Speed: 3000 cpm” and “Feed Speed: 50%”. Then, for example, rotational speed=3000 cpm, feed rate=50% may be sent to the cloud platform as target performance index data.

And wherein, in some embodiments, the index grade information at the local detection terminal may correspond, for example, to the target performance index data grade at the cloud platform side (e.g., they may be the same data), which facilitates subsequent rapid determination at the cloud platform side of its corresponding target performance index data grade based on the received target performance index data (particular index grade information) and subsequent processing.

Based on the above, in the present application, by setting the index grade range of the performance data, setting the index grade information for each index grade range, and sending the corresponding index grade information of the performance data as the target performance index data, so that on the one hand, at the time of processing at the local detection terminal, the corresponding category can be determined for each data based on the grade range, thereby better classifying different performance data so that the corresponding performance range thereof can be unambiguous. On the other hand, by setting the index grade information corresponding to the index grade range, enabling the same data format and information content at the time of data interaction, it is advantageous for the subsequent cloud platform to efficiently and conveniently determine the corresponding target performance index data grade based on the data, further reduce the data amount, and improve the efficiency of the detection process.

In some embodiments, the step of determining by the cloud platform, based on the target performance index data, target abnormality detection algorithm information corresponding to the target performance index data includes determining by the cloud platform, based on the target performance index data, target abnormality detection algorithm information corresponding to the target performance index data via a pre-trained machine learning model.

It should be appreciated that embodiments of the present disclosure are not limited by the specific type of the pre-trained machine learning model, which may be, for example, a clustering model, or may also be other neural network models or comprehensive models.

It will be appreciated that, for example, the target performance index data may be input at an input of a machine learning model and the abnormality detection algorithm information may be obtained at an output of the machine learning model through the processing of the machine learning model (e.g., through the processing of its input layers, intermediate layers, fully connected layers, etc., as examples).

Based on the above, in the present application, by determining the target abnormality detection algorithm information corresponding to the target performance index data via the pre-trained machine learning model based on the target performance index data at the cloud platform, so that as compared with the previous comprehensive calculation performed in the cloud platform, the cloud platform in the present application only needs to set a single pre-trained machine learning model, only needs to solve the target performance index data and determine the corresponding algorithm information, thus reducing the calculation amount of the cloud platform in a large scale.

In some embodiments, the target abnormality detection algorithm information comprises target pre-processing model information, target feature extraction model information, and target abnormality detection model information.

The target pre-processing model information refers to information for an algorithm model required for pre-processing the performance data of the device to be detected, such as the name, number and identification information of the algorithm.

The target feature extraction model information refers to information for an algorithm model used for extracting features from the pre-processed performance data of the device to be detected, such as the name, number, and identification information of the algorithm.

The target abnormality detection model information refers to information for an algorithm model used for determining the abnormality of the device to be detected, such as the name, number, and identification information of the algorithm.

It should be understood that, according to different devices to be detected and different data contents of the target performance index data of the devices, the target pre-processing model information, the target feature extraction model information and the target abnormality detection model information corresponding to the devices to be detected are also different therewith, the embodiments of the present disclosure are not limited by the specific contents of the information.

Based on the above, in the present application, by setting the target abnormality detection algorithm information to include target preprocessing model information, target feature extraction model information and target abnormality detection model information, the cloud platform is enabled to accurately and reliably determine model types for preprocessing, feature extraction, target abnormality detection of the device to be detected based on the target performance index data of the device to be detected, thereby facilitating flexible adjustment of corresponding abnormality detection algorithms according to the current performance situation of the device to be detected and the device type thereof, thereby setting a suitable and highly accurate detection algorithm for each device to be detected, improving accuracy and reliability of the detection process.

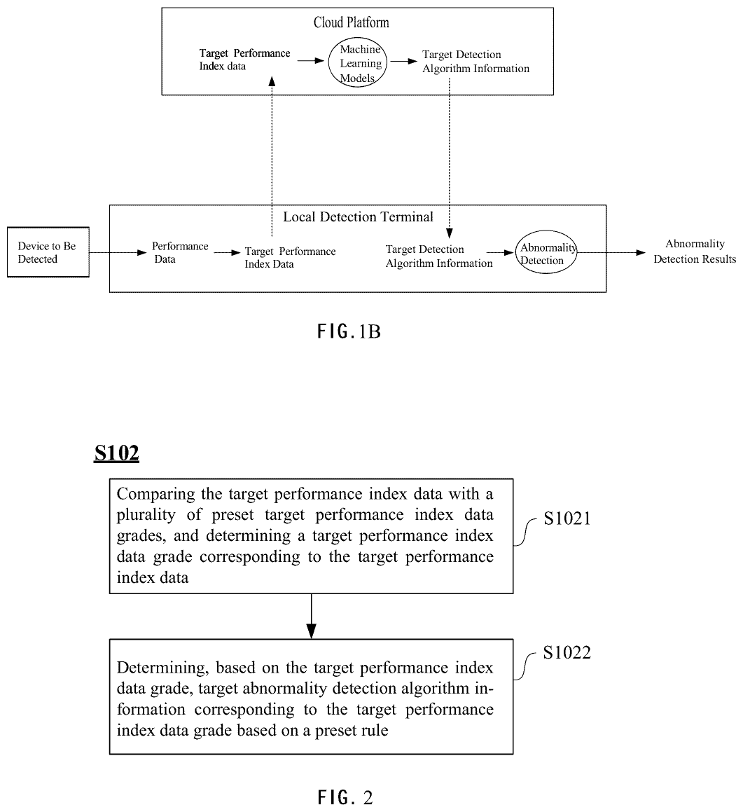

In some embodiments, the process of determining the target abnormality detection algorithm information corresponding to this target performance index data in step S102 may be explained more specifically, for example. FIG. 2 illustrates an exemplary flowchart of the process S102 of determining target abnormality detection algorithm information according to embodiments of the present disclosure.

Referring to FIG. 2, first, in step S1021, the target performance index data is compared with preset target performance index data grades, and a target performance index data grade corresponding to the target performance index data is determined.

The target performance index data grades refer to different grades of the target performance index data that are set in advance. The grade may be a single value, for example, or may be a range of data, and embodiments of the present disclosure are not limited by the specific expression of the data grade.

For example, the target performance index data includes two data types of rotational speed and feed rate, and the rotational speed includes 3000 cpm and 6000 cpm, the feed rate includes 50%, 80%, and 100%. At this time, the target performance index data grade includes, for example, six grades as follows: Grade 1: rotational speed 3000 cpm and feed rate 50%, Grade 2: rotational speed 3000c pm and feed rate 80%, Grade 3: rotational speed 3000 cpm and feed rate 100%, Grade 4: rotational speed 6000 cpm and feed rate 50%, Grade 5: rotational speed 6000 cpm and feed rate 80%, Grade: rotational speed 6000 cpm and feed rate 100%.

The determination of the target performance index data grade corresponding to the target performance index data refers to, for example, the determination of the target performance index data grade into which the target performance index data falls. For example, if the currently obtained target performance index data is: the rotational speed of 3000 cpm and the feed rate of 80%, compared with the aforementioned six grades, the current target performance index data falls into Grade 3, and the corresponding target performance data grade may be determined to be Grade 3.

Thereafter, in step S1022, based on the target performance index data grade, target abnormality detection algorithm information corresponding to the target performance index data grade is determined based on a preset rule.

It should be appreciated that the preset rule may be, for example, a correspondence between a data grade set in advance by the system and a target detection algorithm model. For example, a correspondence table between the data grade and the target detection algorithm model may be set in advance or may be imported in advance by the system. When the data grade of the device to be detected is acquired, the corresponding target detection algorithm model may be determined accordingly, thereby obtaining, for example, target pre-processing model information, target feature extraction model information, and target abnormality detection model information. For example, the target pre-processing model information, the target feature extraction model information, and the target abnormality detection model information may be further spliced to obtain the final target abnormality detection algorithm information.

Based on the above, in the present application, when the cloud platform determines the target abnormality detection algorithm information, the target performance index data grade corresponding to the target performance index data is determined by setting the comparison between the target performance index data with a plurality of preset target performance index data grades; and the target abnormality detection algorithm information corresponding to the target performance index data grade is determining based on the target performance index data grade and based on a preset rule, so that the determination of target abnormality detection algorithm information to be implemented can be realized in a simple and convenient manner, thereby improving the efficiency and reliability of the generating process of the target abnormality detection algorithm information.

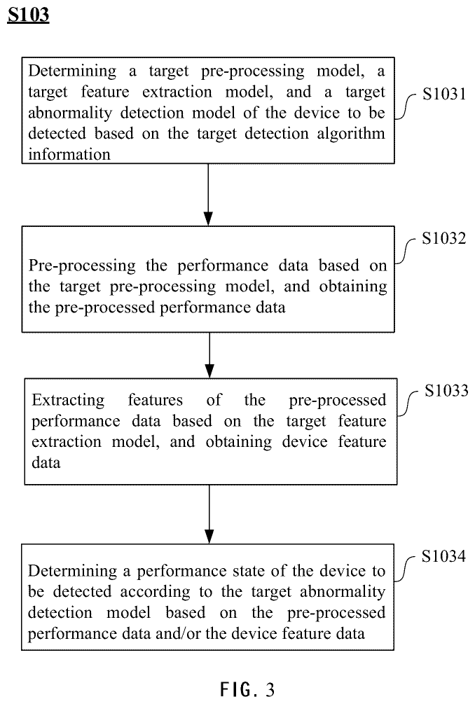

In some embodiments, the process in which the aforementioned local detection terminal implements abnormality detection of the device to be detected based on the target detection algorithm information and the performance data of the device to be detected can be explained more specifically, for example. FIG. 3 illustrates an exemplary flowchart of a process S103 of abnormality detection of the device to be detected according to an embodiment of the present disclosure.

Referring to FIG. 3, in performing abnormality detection, first, in step S1031, a target pre-processing model, a target feature extraction model, and a target abnormality detection model of the device to be detected are determined based on the target detection algorithm information.

For example, if the target detection algorithm information includes, for example, the name of the target pre-processing model, the name of the target feature extraction model, and the name of the target abnormality detection model, and the local detection terminal stores the respective detection models, then the local detection terminal may call, for example, the corresponding target pre-processing model, target feature extraction model, and target abnormality detection model based on the names in the target detection algorithm information.

Thereafter, in step S1032, the performance data is pre-processed based on the target pre-processing model, and the pre-processed performance data is obtained.

The pre-processed performance data refers to data obtained after processing the performance data through the target pre-processing model.

It will be appreciated that according to the actual situation and the particular type of preprocessing model selected, the performance data may be processed in a variety of ways, such as applying a high-pass filter, a low-pass filter, or filters with a different threshold, and that the data may be subjected to a variety of pre-processing processes, such as smoothing, noise reduction, etc., according to the actual model selected. Embodiments of the present disclosure are not limited by these specific pre-processing ways.

After pre-processing, in step S1033, features of the preprocessed performance data are extracted based on the target feature extraction model, to obtain device feature data.

The device feature data refers to feature data obtained after the feature extraction of the pre-processed performance data by the target feature extraction model.

It will be appreciated that the feature extraction process may include, for example, signal analysis processes in time domain and frequency domain; a variety of data feature extraction processes, such as mean, variance, peak, average, and the like. Embodiments of the present disclosure are not limited by the specific content of this target feature extraction model.

After obtaining the characteristic data, in step S1034, the performance state of the device to be detected is determined according to the target abnormality detection model based on the pre-processed performance data and/or the device feature data.

It should be appreciated that the target abnormality detection model may, for example, perform comprehensive processing based on the pre-processed performance data and/or the device feature data and output the performance state of the device to be detected. The target abnormality detection model may be, for example, a one-class support vector machine model (oneclass svm) in which, for example, only the pre-processed performance data and/or the device feature data at normal performance states are included, then the performance state of the device to be detected can be simply and easily determined by comparing the current pre-processed performance data and/or the device feature data with the data in the one-class support vector machine model.

Based on the above, in this application, by setting the local detection terminal to determine a target pre-processing model, a target feature extraction model and a target abnormality detection model of the device to be detected based on target detection algorithm information, and pre-processing the performance data via the target pre-processing model, extracting features of the pre-processed performance data based on the target feature extraction model, determining a performance state of the device to be detected based on the pre-processed performance data and/or the device feature data according to the target abnormality detection model, so that large-scale model solving processes are all completed by the local terminal. Compared with the setting of a large number of computing processes in the cloud terminal in the prior art, the detection method of the present application can significantly reduce the computational amount in the cloud. At the same time, via the best model information determined in the cloud, the local corresponding model is called for processing. Therefore, the present application takes into account the reduction in the computational amount in the cloud and the accuracy of the detection.

In some embodiments, the machine learning model is a clustering model.

The clustering model is a machine learning model derived based on a clustering algorithm. It is characterized by the ability to divide the targets in the dataset into different groups/clusters, with the targets within each cluster having similar characteristics. By employing the clustering model, it is possible to simply and conveniently divide a plurality of different performance data grades and to achieve an efficient determination of corresponding algorithm information based on the target performance index data and the preset plurality of target performance index data grades.

It should be appreciated that embodiments of the present disclosure are not limited by the type of clustering model specifically used, and may be, for example, a kmeans model or other clustering model.

Based on the above, in the present application, by setting the machine learning model to be a clustering model, it is possible to divide the target performance index data into a plurality of grades within the model according to different characteristics, so that the target abnormality detection algorithm information corresponding to the target performance index data can be determined in a simple and convenient manner.

In some embodiments, the device to be detected is, for example, a gear grinder. The gear grinder refers to a gear processing machine that uses a grinding wheel as a grinding tool to process cylindrical gears or some gears (helical gears, bevel gears, etc.) for machining the tooth surface of cutter.

And wherein the target performance index data includes rotational speed data of the gear grinder and feed rate data of the gear grinder; the performance data includes at least one of rotational speed data of the gear grinder, feed rate data of the gear grinder, power data of the gear grinder, and vibration data of the gear grinder.

The rotational speed data of the gear grinder refers to rotational speed data of an output shaft of the grinder.

The feed rate data of the gear grinder is indicative of the cutting rate of the cutter of the gear grinder to the workpiece, i.e., the rate at which the cutter cuts forward in a predetermined cutter path as a spindle rotates at a high speed.

The power data of the gear grinder refers to the overall power parameters of the gear grinder in the current operating state, characterizing the overall power consumption.

The vibration data of the gear grinder refers to the vibration data of the gear grinder during operation.

By providing that the device to be detected is, for example, a gear grinder, and that the target performance index data comprises rotational speed data of the gear grinder, feed rate data of the gear grinder, the performance data comprises at least one of rotational speed data of the gear grinder, feed rate data of the gear grinder, power data of the gear grinder, vibration data of the gear grinder, a more accurate reflection of the performance state of the gear grinder in operation can be realized, thereby improving the accuracy of the detection process.

According to another aspect of the present disclosure, a device-abnormality detection system is proposed, which includes a local detection terminal and a cloud platform, and is configured to perform the method as described above, and has the functions as described above.

Program portions of the technology may be thought of as “products” or “articles of manufacture” in the form of executable code and/or associated data, embodied or embodied via a computer readable medium. Tangible, non-transitory storage media may include memory or storage for use by any computer, processor, or similar device, or associated module. For example, various semiconductor memories, tape drives, disk drives, or any similar device capable of providing storage functionality for software.

All of the software, or portions thereof, may at times communicate over a network, such as the Internet or other communication network. Such communications may load the software from one computer device or processor into another. For example, a hardware platform may be loaded into a computer environment from a server or host computer of the target tracking device, or may be loaded into other computer environment implementing the system, or system of similar functionality associated with providing information needed for target tracking. Thus, another medium capable of transferring software elements may also be used as a physical connection between local devices, such as optical waves, electrical waves, electromagnetic waves, etc., propagating through electrical cables, optical cables, or air. A physical medium used for carrying waves, such as electrical cables, wireless connections, optical cables, and the like, also may be considered as a medium bearing the software. Unless otherwise limited as used herein to tangible “storage” media, other terms representing computer or machine “readable medium” refer to the medium involved in the execution of any instructions by a processor.

The present application uses specific words to describe embodiments of the present application. Reference to “first/second embodiments,” “an embodiment,” and/or “some embodiments” means features, structures, or characteristics in connection with at least one embodiment of the present disclosure. Therefore, it should be emphasized and noted that two or more references to “an embodiment” or “one embodiment” or “an alternative embodiment” in various places throughout this specification are not necessarily referring to the same embodiment. Furthermore, the certain features, structures or characteristics may be combined as suitable in one or more embodiments of the application.

Moreover, one skilled in the art will appreciate that aspects of the present application may be illustrated and described in terms of a number of patentable categories or instances, including any new and useful process, machine, manufacture, or combination of matter, or any new and useful improvement thereof. Accordingly, aspects of the present application may be performed entirely by hardware, entirely by software (including firmware, resident software, micro-code, etc.), or by a combination of hardware and software. The above hardware or software may each be referred to as a “data block,” “module,” “engine,” “unit,” “component,” or “system.” Furthermore, aspects of the present disclosure may be embodied as a computer product embodied in one or more computer readable medium(s) including computer readable program code.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or extremely formal sense unless expressly so defined herein.

The foregoing is illustrative of the present disclosure, and is not to be considered as limiting thereof. Although several exemplary embodiments of this present disclosure have been described, those skilled in the art will readily appreciate that many modifications are possible in the exemplary embodiments without departing from the novel teachings and advantages of this present disclosure. Accordingly, all such modifications are deliberately to be included within the scope of this present disclosure as defined in the claims. It is to be understood that the above is illustrative of the present disclosure and is not to be considered limited to the specific embodiments disclosed, and that modifications to the disclosed embodiments, as well as other embodiments, are deliberately to be included within the scope of the claims. The present disclosure is defined by the claims and their equivalents.

1. A device-abnormality detection method comprising:
generating, by a local detection terminal, target performance index data of a device to be detected, and sending the target performance index data to a cloud platform;
determining, by the cloud platform based on the target performance index data, target detection algorithm information corresponding to the target performance index data, and sending the target detection algorithm information to the local detection terminal; and
implementing, by the local detection terminal, an abnormality detection of the device to be detected based on the target detection algorithm information and performance data of the device to be detected, and outputs an abnormality detection result.

2. The device-abnormality detection method according to claim 1, wherein the generating, by the local detection terminal, target performance index data of the device to be detected comprises:
capturing, by the local detection terminal, performance data of the device to be detected; and
determining, by the local detection terminal, the target performance index data based on a preset rule and the performance data, and sending the target performance index data to the cloud platform.

3. The device-abnormality detection method according to claim 1, wherein the determining, by the cloud platform based on the target performance index data, target detection algorithm information corresponding to the target performance index data comprises:
determining, by the cloud platform based on the target performance index data, the target abnormality detection algorithm information corresponding to the target performance index data, via a pre-trained machine learning model.

4. The device-abnormality detection method according to claim 3, wherein the target abnormality detection algorithm information comprises target pre-processing model information, target feature extraction model information, and target abnormality detection model information.

5. The device-abnormality detection method according to claim 3, wherein the determining target abnormality detection algorithm information corresponding to the target performance index data comprises:
comparing the target performance index data with a plurality of preset target performance index data grades, determining a target performance index data grade corresponding to the target performance index data; and
determining target abnormality detection algorithm information corresponding to the target performance index data grade, based on the target performance index data grade and based on a preset rule.

6. The device-abnormality detection method according to claim 3, wherein the implementing, by the local detection terminal, the abnormality detection of the device to be detected based on the target detection algorithm information and performance data of the device to be detected comprises:
determining a target pre-processing model, a target feature extraction model, and a target abnormality detection model of the device to be detected, based on the target detection algorithm information;
pre-processing the performance data based on the target pre-processing model, to obtain pre-processed performance data;
extracting features of the pre-processed performance data based on the target feature extraction model to obtain device feature data; and
determining a performance state of the device to be detected according to the target abnormality detection model based on the pre-processed performance data and/or the device feature data.

7. The device-abnormality detection method according to claim 3, wherein the machine learning model is a clustering model.

8. The device-abnormality detection method according to claim 2, wherein the determining target performance index data based on the preset rule and based on the performance data comprises:
for at least one of the performance data:
acquiring data types of the performance data and obtaining index grade ranges corresponding to the data types, wherein each index grade range has corresponding index grade information;
determining an index grade range to which the performance data corresponds, and acquiring the corresponding index grade information; and
generating target performance index data based on the index grade information corresponding to each of the performance data.

9. The device-abnormality detection method according to claim 1,
wherein the device to be detected is a gear grinder, and
wherein the target performance index data includes rotational speed data of the gear grinder and feed rate data of the gear grinder; and the performance data includes at least one of rotational speed data of the gear grinder, feed rate data of the gear grinder, power data of the gear grinder, vibration data of the gear grinder.

10. A device-abnormality detection system comprising a local detection terminal and a cloud platform, and configured to perform the method of claim 1.

11. A device-abnormality detection system comprising a local detection terminal and a cloud platform, and configured to perform the method of claim 4.

12. A device-abnormality detection system comprising a local detection terminal and a cloud platform, and configured to perform the method of claim 9.
